(19) United States
(12) Patent Application Publication
(10) Pub. No.: US 2015/0213097 A1
(43) Pub. Date: Jul. 30, 2015

(54) NON-TRANSITORY COMPUTER READABLE MEDIUM AND ATTRIBUTE INFORMATION PROVIDING APPARATUS

(71) Applicant: FUJI XEROX CO., LTD., Tokyo (JP)

(72) Inventors: Yohei YAMANE, Yokohama-shi (JP); Hiroshi UMEMOTO, Yokohama-shi (JP)

(73) Assignee: FUJI XEROX CO., LTD., Tokyo (JP)

(21) Appl. No.: 14/683,289

(22) Filed: Apr. 10, 2015

Related U.S. Application Data
(63) Continuation of application No. PCT/JP2013/065327, filed on Jun. 3, 2013.

(30) Foreign Application Priority Data
Nov. 12, 2012 (JP) 2012-248066

(51) Int. Cl. G06F 17/30

(52) U.S. Cl. CPC G06F 17/30554; G06F 17/3053

(57) ABSTRACT

An attribute information providing apparatus includes: an acquisition unit that acquires a candidate attribute value of an attribute information piece registered in association with one document information piece from attribute information pieces associated with other document information pieces; and a display unit that determines priority and performs display of the candidate attribute value on a basis of the priority, the priority being determined on a basis of a number of matching information pieces in a case where the attribute information pieces associated with the other document information pieces are searched by using as a search string the candidate attribute value acquired by the acquisition unit.

### CROSS REFERENCE TO RELATED APPLICATION

This is a continuation of International Application No. PCT/JP2013/065327 filed on Jun. 3, 2013, and claims priority from Japanese Patent Application No. 2012-248066, filed on Nov. 12, 2012.

### BACKGROUND

1. Technical Field

The present invention relates to a non-transitory computer readable medium and an attribute information providing apparatus.

2. Related Art

In the related art, an attribute information providing apparatus that analyzes document information to automatically provide attribute information has been proposed.

### SUMMARY

An aspect of the present invention provides a non-transitory computer readable medium storing an attribute information providing program causes a computer to function as: an acquisition unit that acquires a candidate attribute value of an attribute information piece registered in association with one document information piece from attribute information pieces associated with other document information pieces; and a display unit that determines priority and performs display of the candidate attribute value on a basis of the priority, the priority being determined on a basis of a number of matching information pieces in a case where the attribute information pieces associated with the other document information pieces are searched by using as a search string the candidate attribute value acquired by the acquisition unit.

### BRIEF DESCRIPTION OF THE DRAWINGS

Exemplary embodiment(s) of the present invention will be described in detail based on the following figures, wherein:

FIG. 1 is a block diagram illustrating an example of a configuration of an attribute information providing apparatus;

FIG. 2 is a schematic diagram illustrating an example of inputting attribute terms in an attribute-information input field;

FIG. 3 is a schematic diagram illustrating a result of determination by an attribute-information determination unit;

FIG. 4 is a schematic diagram illustrating a result of tallying by an attribute-candidate acquisition unit;

FIG. 5 is a schematic diagram illustrating an example of attribute candidates displayed in the attribute-information input field;

FIG. 6 is a schematic diagram illustrating an example of a configuration of the attribute-information input field after a new attribute term is inserted into the attribute-information input field;

FIG. 7 is a schematic diagram illustrating an example of attribute candidates displayed in the attribute-information input field;

FIG. 8 is a schematic diagram illustrating an example of a configuration of the attribute-information input field in which display is changed;

FIG. 9 is a flowchart illustrating an example of operation of the attribute information providing apparatus;

FIG. 10 is a schematic diagram illustrating an example of a configuration of similar document information pieces;

FIG. 11 is a schematic diagram illustrating an example of a configuration of a similar-document tally result;

FIG. 12 is a schematic diagram illustrating an example of a configuration of a result of tallying by the attribute-candidate acquisition unit;

FIG. 13 is a schematic diagram illustrating an example of attribute candidates displayed in the attribute-information input field;

FIGS. 14A and 14B are schematic diagrams illustrating an example of a configuration of a result of search tallying by the attribute-candidate acquisition unit;

FIG. 15 is a schematic diagram illustrating an example of attribute candidates illustrated in the attribute-information input field; and

FIG. 16 is a schematic diagram illustrating another example of the configuration of attribute candidates displayed in the attribute-information input field.

### DETAILED DESCRIPTION

### First Embodiment

### Configuration of Attribute Information Providing Apparatus

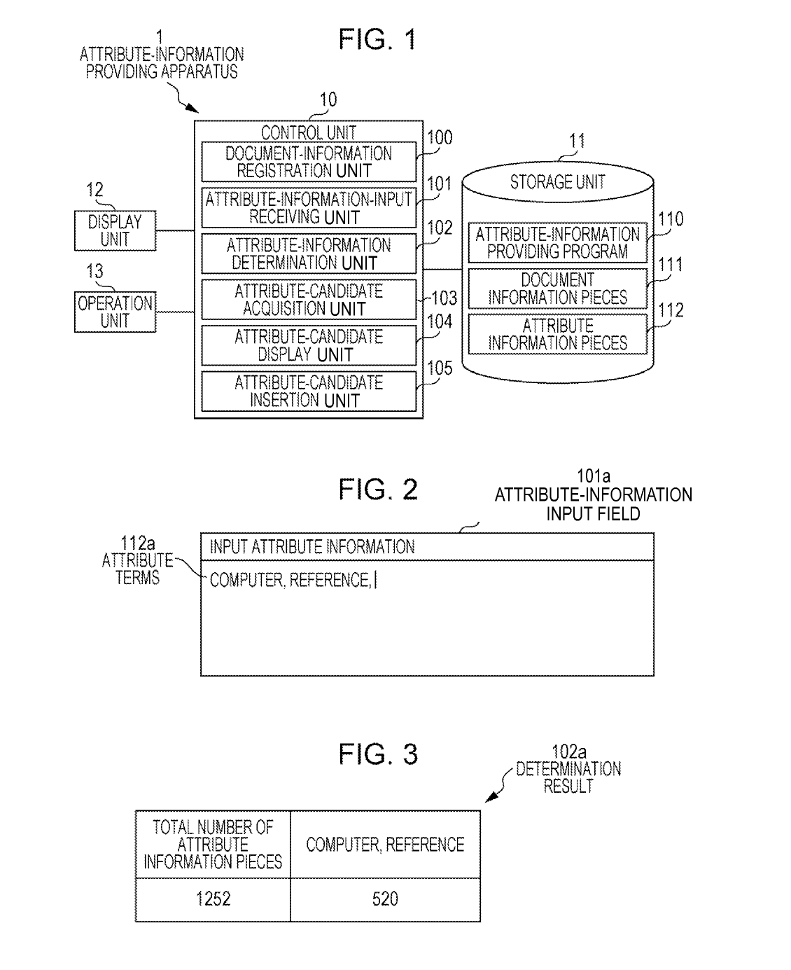

FIG. 1 is a block diagram illustrating an example of a configuration of an attribute-information providing apparatus 1.

The attribute-information providing apparatus 1 includes a control unit 10, a storage unit 11, an operation unit 13, and a display unit 12 such as a liquid crystal display. The control unit 10 includes a CPU and the like, controls components, and executes various programs. The storage unit 11 includes a recording medium such as an HDD (Hard Disk Drive) or a flash memory and serves as an example of a storage device in which information is stored. The operation unit 13 includes a keyboard, a touch panel, and the like for an inputting operation.

The control unit 10 executes an attribute-information providing program 110 that will be described later and thereby functions as a document-information registration unit 100, an attribute-information-input receiving unit 101, an attribute-information determination unit 102, an attribute-candidate acquisition unit 103, an attribute-candidate display unit 104, an attribute-candidate insertion unit 105, and the like.

The document-information registration unit 100 registers a new document information piece in document information pieces 111 in the storage unit 11 in response to a registration request.

The attribute-information-input receiving unit 101 receives input of attribute terms as attribute values of an attribute information piece to be registered in association with the new document information piece. Note that each of the attribute terms may be further provided with a category. In addition, a case where a plurality of attribute terms are received is hereinafter described, but a single attribute term may be received.

In a case where attribute information pieces 112 are searched by using, as search keywords, the plurality of attribute terms received by the attribute-information-input receiving unit 101, the attribute-information determination unit 102 determines whether the degree of narrowing down of a result of the searching is not higher than a predetermined value. Note that the degree of narrowing down is, for example, a proportion of the number of matching information pieces relative to the total number of the attribute information pieces 112 in a case of a search by using search keywords.

In a case where the attribute-information determination unit 102 determines that the degree of narrowing down is higher than the predetermined value, the attribute-candidate acquisition unit 103 acquires one or a plurality of candidate attribute terms from the attribute information pieces 112 registered in past times.

The attribute-candidate display unit 104 displays the candidate attribute terms and the numbers of information pieces as a list on the display unit 12, the candidate attribute terms being acquired by the attribute-candidate acquisition unit 103, the numbers of information pieces each representing how many information pieces match a corresponding one of the candidate attribute terms in a case where the attribute information pieces 112 are searched.

A user selects one of the candidate attribute terms displayed as a list on the display unit 12 by the attribute-candidate display unit 104, and the attribute-candidate insertion unit 105 inserts the selected candidate into the attribute information piece to be registered.

In the storage unit 11, the attribute-information providing program 110, the document information pieces 111, and the attribute information pieces 112 are stored.

The attribute-information providing program 110 is a program causing the control unit 10 to operate as the foregoing units 100 to 105.

The document information pieces 111 are document information including text information, image information, audio information, moving image information, and the like. The type of information is not particularly limited.

Each of the attribute information pieces 112 is an attribute term associated with a corresponding one of the document information pieces 111 and is registered in advance.

Note that the attribute-information providing apparatus 1 is, for example, a personal computer. A mobile phone, a tablet terminal, or the like other than the personal computer may be used.

In addition, the control unit 10 and the storage unit 11 may form a server apparatus in which the operation unit 13 and the display unit 12 are omitted, the server apparatus operating in response to a request from an external terminal.

In addition, a plurality of server apparatuses may be used to form the control unit 10 and the storage unit 11, the server apparatuses operating in response to a request from an external terminal.

### Operation of Attribute Information Providing Apparatus

Next, operations of the present embodiment will be described.

A user of the attribute-information providing apparatus 1 first operates the operation unit 13 to register a new document information piece in the document information pieces 111 in the storage unit 11 and to input attribute terms for registering an attribute information piece in association with the registered document information piece.

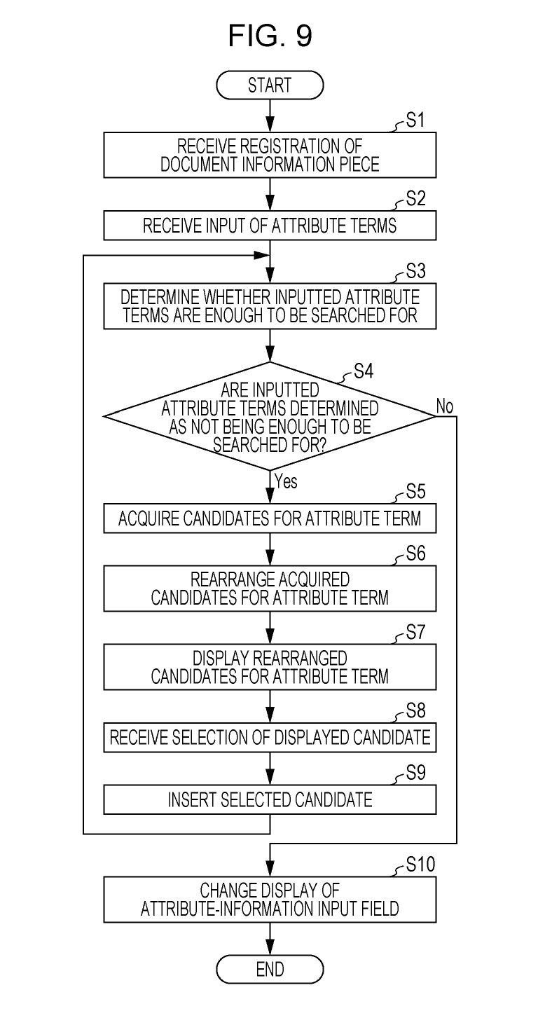

FIG. 9 is a flowchart illustrating an example of operation of the attribute-information providing apparatus 1.

The document-information registration unit 100 of the attribute-information providing apparatus 1 first receives the user's operation for registering the document information piece and registers the document information piece in the document information pieces 111 in the storage unit 11 (S1).

Next, the attribute-information-input receiving unit 101 displays an attribute-information input field illustrated in FIG. 2 on the display unit 12 and receives the input of the attribute terms (S2).

FIG. 2 is a schematic diagram illustrating an example of inputting attribute terms in the attribute-information input field.

An attribute-information input field 101a is a display region displayed on the display unit 12 and for inputting a plurality of attribute terms 112a. In the example in FIG. 2, two attribute terms “computer” and “reference” are inputted.

Next, the attribute-information determination unit 102 determines whether “computer” and “reference” that are the attribute terms inputted into the attribute-information input field 101a satisfy a criterion predetermined for searching (S3). The determination is made by using the method described below.

The attribute-information determination unit 102 first performs an AND search on the attribute information pieces 112 by using the two conditions “computer” and “reference”, acquires the number of matching information pieces, and compares the number of matching information pieces with the total number of attribute information pieces 112 to have a determination result.

FIG. 3 is a schematic diagram illustrating a result of determination performed by the attribute-information determination unit 102.

A determination result 102a has the total number of attribute information pieces of “1252” and the number of information pieces matching both “computer” and “reference” of “520”.

Assume a case where the proportion of the number of matching information pieces of “520” described above relative to the total number of attribute information pieces “1252” is not lower than “0.01” taken as an example of the predetermined value, the proportion being 520÷1252=0.415 . . . . In this case, the attribute-information determination unit 102 determines that the attribute information piece containing the attribute terms “computer” and “reference” is not an attribute information piece satisfying the criterion predetermined for searching (S4; Yes). In other words, the attribute-information determination unit 102 determines that the use of only the attribute terms “computer” and “reference” does not enable narrowing down according to the predetermined criterion to be performed when searching is performed.

Next, the attribute-candidate acquisition unit 103 acquires, from the attribute information pieces 112 inputted in past times, candidates for an attribute term to be further added to the attribute terms “computer” and “reference” (S5). The acquisition is performed by using the method described below.

The attribute-candidate acquisition unit 103 acquires attribute terms inputted simultaneously with “computer” and “reference” in the attribute information pieces 112. The attribute-candidate acquisition unit 103 further acquires the number of matching information pieces in a case where “computer”, “reference” and each simultaneously inputted attribute term are used to search the attribute information pieces 112 and obtains a tally result described below.

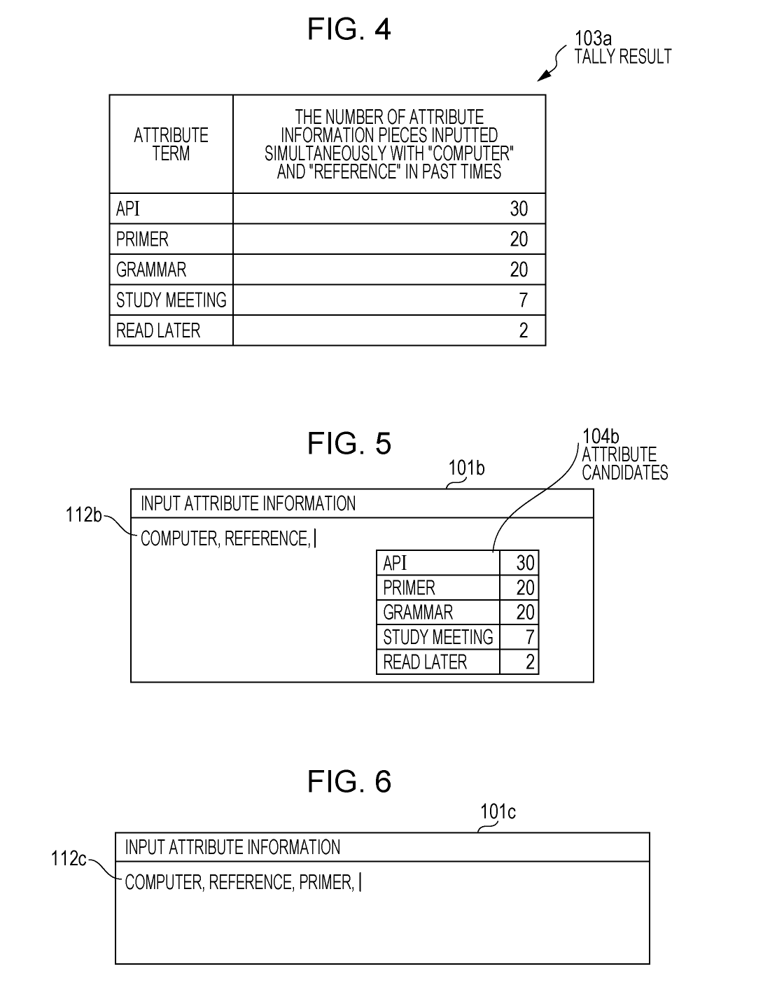

FIG. 4 is a schematic diagram illustrating a result of tallying by the attribute-candidate acquisition unit 103.

A tally result 103a has attribute terms and the numbers of information pieces, the attribute terms being inputted simultaneously with “computer” and “reference” in the attribute information pieces 112, the numbers of information pieces each representing how many information pieces match “computer”, “reference” and a corresponding one of the simultaneously inputted attribute terms in a case where the attribute information pieces 112 are searched.

In the example in FIG. 4, the attribute-candidate acquisition unit 103 acquires “API”, “primer”, “grammar”, “study meeting”, and “read later” as the attribute terms and acquires “30”, “20”, “20”, “7”, and “2” as the numbers of information pieces matching the attribute terms, respectively.

Next, in a case where the attribute terms in FIG. 4 described above are not arranged according to the number of matching information pieces, the attribute-candidate display unit 104 rearranges the attribute terms according to the number of matching information pieces (S6), and displays candidates that are the rearranged attribute terms as attribute candidates 104b on the display unit 12 (S7).

Note that in addition to rearranging attribute terms according to the number of matching information pieces, the attribute-candidate display unit 104 may calculate an average and a standard deviation of the number of matching information pieces to display attribute terms within a range of a constant multiple of the standard deviation from the average. In this manner, the attribute-candidate display unit 104 may omit attribute terms having a too large and a too small number of matching information pieces. Alternatively, the attribute-candidate display unit 104 may only rearrange attribute terms according to the number of matching information pieces, and the attribute-candidate acquisition unit 103 may acquire attribute terms each having the number of matching information pieces within a range of a constant multiple of the standard deviation from the average.

FIG. 5 is a schematic diagram illustrating an example of the attribute candidates displayed in the attribute-information input field.

An attribute-information input field 101b is displayed on the display unit 12 and indicates a state after input of a plurality of attribute terms 112b into the attribute-information input field 101a. The attribute-information input field 101b has the attribute candidates 104b. Each of the attribute candidates 104b represents a corresponding one of the rearranged attribute terms and is provided with the number of information pieces matching the attribute term.

With reference to the number of matching information pieces, the user selects one of the attribute terms in the attribute candidates 104b, the attribute term matching the content of the document information piece registered in step S1. The user herein selects, for example, “primer”.

Next, the attribute-candidate insertion unit 105 receives the selection of the attribute term “primer” by the user (S8) and inserts the attribute term “primer” into the attribute information piece containing “computer” and “reference” (S9).

FIG. 6 is a schematic diagram illustrating an example of a configuration of the attribute-information input field after a new attribute term is inserted into the attribute-information input field.

An attribute-information input field 101c contains “computer”, “reference”, and “primer” as attribute terms 112c.

Steps S3 to S9 described above are repeated until the attribute-information determination unit 102 determines that the inputted attribute terms satisfy the criterion predetermined for searching.

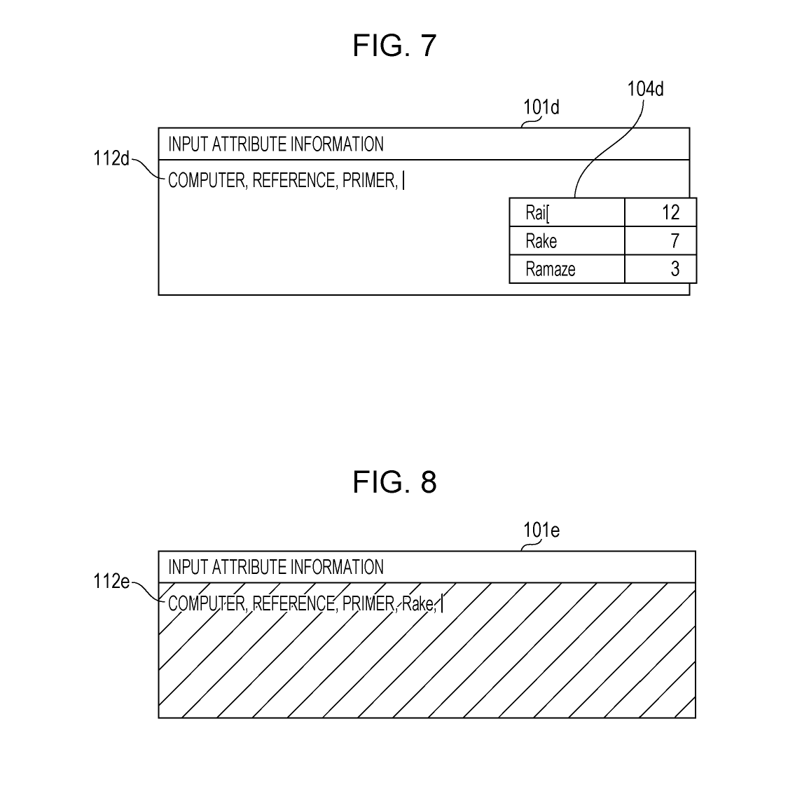

The proportion is 20÷1252=0.015 . . . when the attribute term “primer” is inserted, and is thus not smaller than the predetermined value of “0.01”. The attribute-information determination unit 102 determines that the attribute information piece does not satisfy the criterion predetermined for searching (S4; Yes). The attribute-candidate acquisition unit 103 and the attribute-candidate display unit 104 execute steps S5 to S7 and display new candidate attribute terms, as illustrated in FIG. 7.

FIG. 7 is a schematic diagram illustrating an example of the attribute candidates displayed in the attribute-information input field.

An attribute-information input field 101d indicates a state after input of a plurality of attribute terms 112d into the attribute-information input field 101c. Each of the newly displayed attribute candidates 104d represents a corresponding one of the rearranged attribute terms in the attribute-information input field 101d and is provided with the number of information pieces matching the attribute term.

With reference to the number of matching information pieces, the user selects one of the attribute terms of the attribute candidates 104d. The user herein selects, for example, “Rake”.

The proportion is 7÷1252=0.005 . . . when the attribute term “Rake” is inserted, and is thus smaller than the predetermined value of “0.01”. The attribute-information determination unit 102 determines that the attribute information piece satisfies the criterion predetermined for searching (S4; No) and changes the display of the attribute-information input field to a display as described below (S10).

FIG. 8 is a schematic diagram illustrating an example of a configuration of an attribute-information input field in which display is changed.

An attribute-information input field 101e has the attribute terms “computer”, “reference”, “primer”, and “Rake”. In the attribute-information input field 101e, the overall display is changed to have a color or the like that attracts the user's attention. The display is different from those of the attribute-information input fields 101a to 101d.

### Advantageous Effects of First Embodiment

According to the embodiment described above, when an attribute information piece is registered in association with a document information piece, it is determined whether inputted attribute terms satisfy the criterion predetermined for narrowing down the number of document information pieces. If the inputted attribute terms do not satisfy the predetermined criterion, attribute candidates are acquired, the attribute information pieces 112 are searched by using the inputted attribute terms and the acquired attribute candidates, and thereby the number of matching information pieces is presented. If the inputted attribute terms satisfy the predetermined criterion, the display is changed as in the attribute-information input field 101e. Thus, candidate attribute terms satisfying the criterion predetermined for narrowing down the number of information pieces when the document information pieces are searched may be presented to the user.

### Second Embodiment

Steps S5 to S7 in FIG. 9 may be performed in the following manner.

The attribute-candidate acquisition unit 103 first acquires document information pieces having a high similarity to the document information piece registered in step S1 from the document information pieces 111 and calculates the degree of similarity. Here, to calculate the degree of similarity among the document information pieces, for example, vectors are generated from words appearing in the document information pieces, and a vector space method or the like is used. The attribute-candidate acquisition unit 103 also acquires the attribute terms of attribute information pieces associated with the document information pieces having a high degree of similarity and generates similar document information pieces from these.

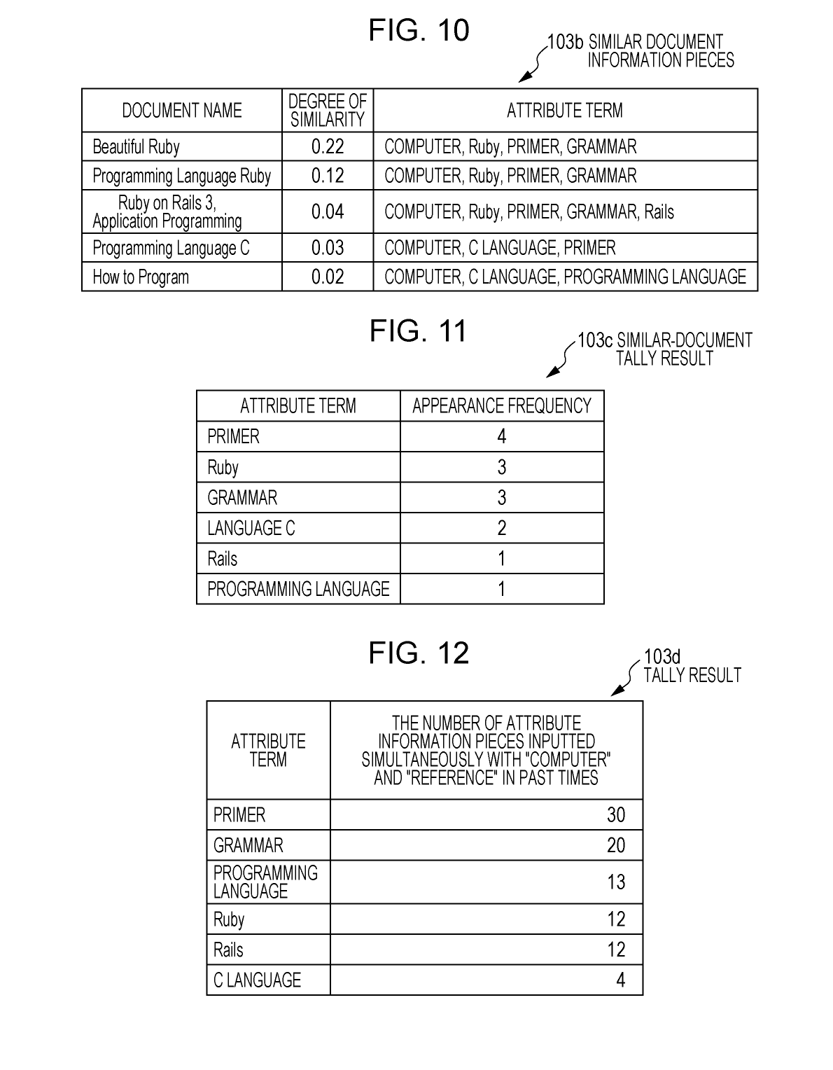

FIG. 10 is a schematic diagram illustrating an example of a configuration of the similar document information pieces.

Similar document information pieces 103b each have a document name of a document information piece, the degree of similarity to the document information piece registered in step S1, and attribute terms included in the associated attribute information piece. The similar document information pieces 103b are, for example, top five information pieces having a high degree of similarity.

The attribute-candidate acquisition unit 103 calculates the appearance frequency of each of the attribute terms of the similar document information pieces 103b and obtains a similar-document tally result described below.

FIG. 11 is a schematic diagram illustrating an example of a configuration of the similar-document tally result.

A similar-document tally result 103c has attribute terms and appearance frequencies.

Next, the attribute-candidate acquisition unit 103 acquires the number of matching information pieces in the case where each attribute term in the similar-document tally result 103c, “computer”, and “reference” are used to search the attribute information pieces 112 and obtains a tally result.

FIG. 12 is a schematic diagram illustrating an example of a configuration of the result of tallying by the attribute-candidate acquisition unit 103.

A tally result 103d has attribute terms and the numbers of information pieces, the attribute terms being inputted simultaneously with “computer” and “reference” in the attribute information pieces 112, the numbers of information pieces each representing how many information pieces match “computer”, “reference”, and a corresponding one of the attribute terms in the case where the attribute information pieces 112 are searched.

Next, in the case where the attribute terms in FIG. 12 described above are not arranged according to the number of matching information pieces, the attribute-candidate display unit 104 rearranges the attribute terms according to the number of matching information pieces (S6) and displays, on the display unit 12, candidates that are the rearranged attribute terms as attribute candidates 104f (S7).

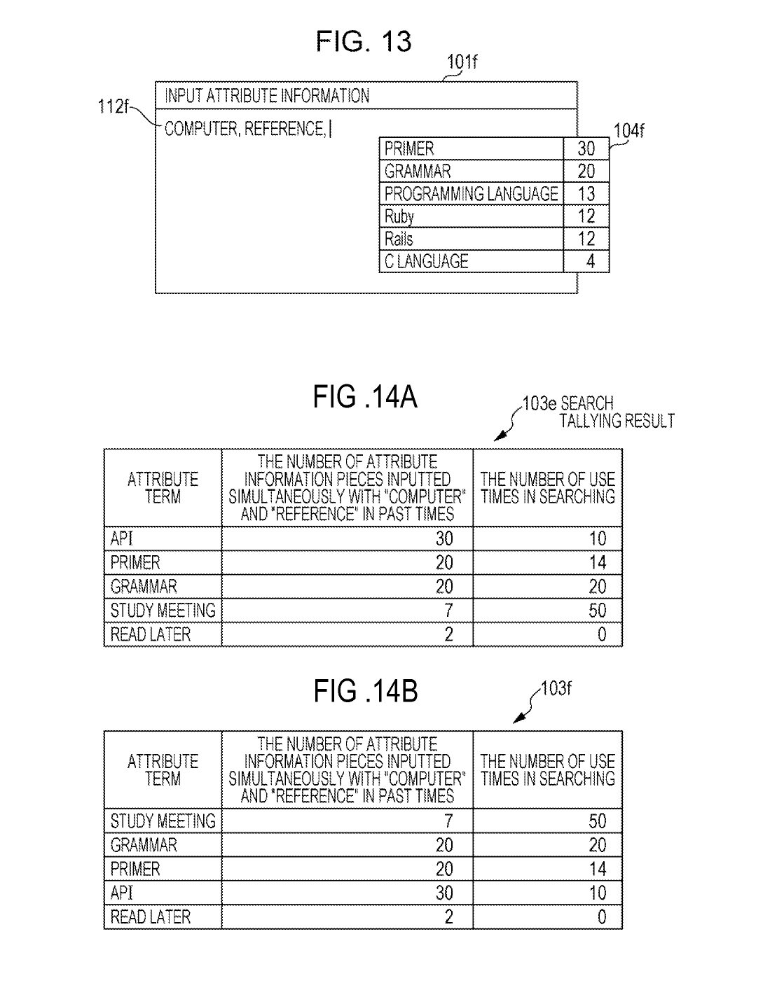

FIG. 13 is a schematic diagram illustrating an example of the attribute candidates displayed in the attribute-information input field.

An attribute-information input field 101f is displayed on the display unit 12 and indicates a state after input of a plurality of attribute terms 112f. The attribute-information input field 101f has the attribute candidates 104f. Each of the attribute candidates 104f represents a corresponding one of the rearranged attribute terms and the number of information pieces matching the attribute term.

### Advantageous Effects of Second Embodiment

According to the embodiment described above, in addition to the advantageous effects of the first embodiment, candidate attribute terms satisfying the criterion predetermined for narrowing down the number of information pieces when the document information pieces are searched may be be presented to the user in consideration of the degree of similarity to each document information piece 111.

### Third Embodiment

Steps S5 to S7 in FIG. 9 may be performed in the following manner.

In addition to the tally result 103a that is illustrated in FIG. 4 and that is acquired in step S5, the attribute-candidate acquisition unit 103 first acquires the number of times of using each attribute term as a search keyword, from search history information that is not illustrated and acquires a search tallying result.

FIGS. 14A and 14B are each a schematic diagram illustrating an example of a configuration of the result of search tallying by the attribute-candidate acquisition unit 103.

As illustrated in FIG. 14A, a search tallying result 103e has attribute terms, the numbers of information pieces, and the numbers of times, the attribute terms being inputted simultaneously with “computer” and “reference” in the attribute information pieces 112, the numbers of information pieces each representing how many information pieces match “computer”, “reference”, and a corresponding one of the inputted simultaneously attribute terms in the case where the attribute information pieces 112 are searched, the numbers of times each representing how many times the attribute term is used as a search keyword.

Next, the attribute-candidate acquisition unit 103 performs rearrangement on the search tallying result 103e according to the number of times of using the attribute term in searching and obtains the search tallying result 103f as illustrated in FIG. 14B.

Next, the attribute-candidate display unit 104 displays, as attribute candidates 104g, candidates that are the attribute terms on the display unit 12 according to the number of times of using the attribute term in searching described above with reference to FIG. 14B.

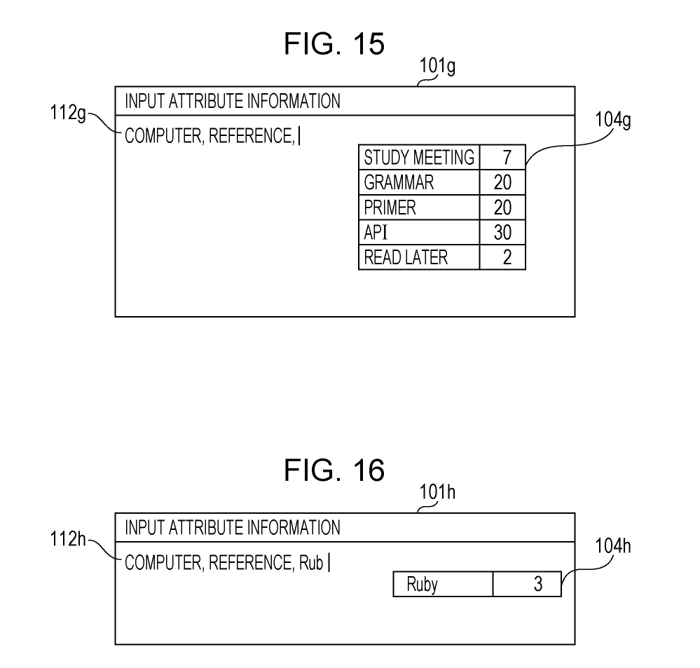

FIG. 15 is a schematic diagram illustrating an example of the attribute candidates illustrated in the attribute-information input field.

An attribute-information input field 101g indicates a state after input of a plurality of attribute terms 112g. The attribute-information input field 101g has the attribute candidates 104g. Each of the attribute candidates 104g represents a corresponding one of the rearranged attribute terms and is provided with the number of information pieces matching the attribute term.

### Advantageous Effects of Third Embodiment

According to the embodiment described above, in addition to the advantageous effects of the first embodiment, candidate attribute terms satisfying the criterion predetermined for narrowing down the number of information pieces when the document information pieces are searched may be presented to the user in consideration of keywords used in searching in past times.

### Other Embodiments

Note that the present invention is not limited to the aforementioned embodiments, and various modifications may be made without departing from the spirit of the present invention. For example, a modification may be made as described below.

FIG. 16 is a schematic diagram illustrating another example of the configuration of attribute candidates displayed in the attribute-information input field.

In a case where “Rub” is inputted as a half inputted attribute term after “computer” and “reference” are inputted as attribute terms 112h into an attribute-information input field 101h, the attribute-candidate acquisition unit 103 acquires an attribute term matching “Rub” by right truncation from the attribute information pieces 112. The attribute-candidate acquisition unit 103 also acquires the number of matching information pieces in a case where the attribute information pieces 112 are searched by using “computer”, “reference” and the acquired attribute term.

Next, the attribute-candidate display unit 104 displays, on the display unit 12, a candidate that is the acquired attribute term and the number of matching information pieces, as an attribute candidate 104h.

This makes it possible to present to the user to what extent narrowing down is feasible when searching is performed by using a half inputted attribute term.

Although the functions of the units 100 to 105 in the control unit 10 are implemented by the program in the embodiments described above, all or some of the units may be implemented by hardware such as an ASIC. In addition, the program used in the embodiments described above may also be provided, being stored in a recording medium such as a CD-ROM. Moreover, mutual changes, deletions, additions, and the like of the steps described above in the aforementioned embodiments may be made without departing from the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing an attribute information providing program for causing a computer to function as:
an acquisition unit that acquires a candidate attribute value of an attribute information piece registered in association with one document information piece from attribute information pieces associated with other document information pieces; and
a display unit that determines priority and performs display of the candidate attribute value on a basis of the priority, the priority being determined on a basis of a number of matching information pieces in a case where the attribute information pieces associated with the other document information pieces are searched by using as a search string the candidate attribute value acquired by the acquisition unit,
a determination unit that determines whether narrowing down to a predetermined number of matching information pieces is feasible in the case where the attribute information pieces associated with the other document information pieces are searched by using the candidate attribute value as the search string, wherein
in a case where the determination unit determines that narrowing down to the predetermined number of matching information pieces is not feasible, the acquisition unit further acquires the candidate attribute value, and
in a case where the determination unit determines that narrowing down to the predetermined number of matching information pieces is feasible, the display unit changes the display.

2. The non-transitory computer readable medium according to claim 1, wherein
the acquisition unit acquires, as the candidate attribute value, an attribute value frequently appearing in an attribute information piece associated with a document information piece similar to the one document information piece among the other document information pieces.

3. The non-transitory computer readable medium according to claim 1, wherein
the display unit acquires a history information piece regarding searching the attribute information pieces and performs display of the candidate attribute value, with the priority being changed on a basis of an attribute value frequently appearing as a search string when searching is performed in the history information piece.

4. An attribute information providing apparatus comprising:
an acquisition unit that acquires a candidate attribute value of an attribute information piece registered in association with one document information piece from attribute information pieces associated with other document information pieces; and
a display unit that determines priority and performs display of the candidate attribute value on a basis of the priority, the priority being determined on a basis of a number of matching information pieces in a case where the attribute information pieces associated with the other document information pieces are searched by using as a search string the candidate attribute value acquired by the acquisition unit,
a determination unit that determines whether narrowing down to a predetermined number of matching information pieces is feasible in the case where the attribute information pieces associated with the other document information pieces are searched by using the candidate attribute value as the search string, wherein
in a case where the determination unit determines that narrowing down to the predetermined number of matching information pieces is not feasible, the acquisition unit further acquires the candidate attribute value, and
in a case where the determination unit determines that narrowing down to the predetermined number of matching information pieces is feasible, the display unit changes the display.

5. The attribute information providing apparatus according to claim 4, wherein
the acquisition unit acquires, as the candidate attribute value, an attribute value frequently appearing in an attribute information piece associated with a document information piece similar to the one document information piece among the other document information pieces.

6. The attribute information providing apparatus according to claim 4, wherein
the display unit acquires a history information piece regarding searching the attribute information pieces and performs display of the candidate attribute value, with the priority being changed on a basis of an attribute value frequently appearing as a search string when searching is performed in the history information piece.
